(19) United States
(12) Patent Application Publication
(10) Pub. No.: US 2007/0255911 A1
(43) Pub. Date: Nov. 1, 2007

(54) Method of optimising writing by a master block into a fifo type interfacing device between this master block and a slave block, and the corresponding computer program product

(75) Inventors: Sylvain Garnier, Nantes (FR); Thierry Delalande, Nantes (FR); Laurentiu Birsan, Bouguenais (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Atmel Nantes SA, Nantes Cedex (FR)

(21) Appl. No.: 11/728,198

(22) Filed: Mar. 23, 2007

(30) Foreign Application Priority Data
Mar. 24, 2006 (FR) 06/02617

(51) Int. Cl. G06F 13/00

(52) U.S. Cl. 711/154

(57) ABSTRACT

A method for optimising writing by a master block into an interfacing device between the master block and a slave block. The method includes a step for transformation of a code into assembler language, done before the code in machine language is obtained and including the following steps: transformation of all static unit writes comprising more than one word from the assembler language code into one-word static unit writes; search for each set of N successive static one-word unit writes; replace at least one set of N successive static one-word unit writes by one static unit N-word write of, in the assembler language code, where N is an integer greater than or equal to 2.

### CROSS-REFERENCE TO RELATED APPLICATION

None.

### FIELD OF THE DISCLOSURE

The field of the disclosure is electronic circuits.

More precisely, one embodiment of the disclosure relates to a method of optimising writing by a master block into an interfacing device enabling single-directional interfacing between this master block and a slave block. For example, the master and slave blocks may be a microprocessor and a coprocessor included in an audio codec.

### BACKGROUND

It is assumed that the master block executes a code in machine language (or 1GL for “First Generation Language”) obtained from a code in assembler language (or 2GL for “Second Generation Language”) including a series of unit writes used to write word groups. These word groups are instructions that will be read and executed by the slave block each comprising an operation code (or opcode) word and k operand words (or “data words”), where k≧0. Therefore, word groups have variable sizes from 1 word to k+1 words.

It is also assumed that the master block that writes word groups into the interfacing device comprises a write bus (also called an interface bus), the size of which is equal to N*T, where N is an integer greater than or equal to two.

The FIFO type interfacing device enables elasticity in execution of the microprocessor code and the coprocessor code. Conventionally, it includes a memory plane managed by a First In First Out (FIFO) mode, with write and read pointers. This memory plane can be used to store words from the master block through an input bus. The interfacing device (also called “FIFO memory” in the following description) also includes an output registers bank that can contain words read in the memory plane, supplying an output signal that can be read by the slave block. It receives read requests from the slave block and write requests from the master block.

The method according to one embodiment of the disclosure is particularly but not exclusively applicable in the case in which the interfacing device, the master block and the slave block are of the type presented in French patent application No. FR 0507988 deposited on Jul. 26 2005 by the Applicant of this patent application.

We will now present the disadvantages of prior art with reference to the particular application described above, in which the master block is a microprocessor (also called the CPU in the following) and the slave block is a coprocessor (also called DSP in the following), and in which the variable size groups of words are instructions that the microprocessor transmits through the interfacing device to the coprocessor so that it can execute them. However, it is clear that this discussion can be generalised to all types of master and slave blocks.

Remember that for writing words in the memory plane of the interfacing device, the microprocessor sends write requests and places words on the input bus of the interfacing device. For reading words, the coprocessor sends read requests and reads words on the output bus from the interfacing device.

Traditionally, stuffing words are used to manage alignment of words read by the coprocessor in the memory plane of the interfacing device. The interfacing device must store variable size instructions in its memory plane and reproduce them respecting an alignment, such that for each instruction, the coprocessor receives the operation code word (opcode) possibly followed by one or several operand words that must be correctly aligned in its instruction register. FIG. 1 shows this traditional technique for management of alignment with an example memory plane of a standard FIFO memory (interfacing device) with a size of 64 words. The dimensions for a standard FIFO memory are fixed. The number of lines of n bit words is fixed in hardware. Each line includes a determined number of words equal to the maximum size of an instruction. Thus, in the example in FIG. 1, there are 16 lines with 4 words each (in this example it is assumed that one instruction contains a maximum of four words). In order to manage alignment of words in the memory plane, the microprocessor systematically writes 4 words in the memory plane for each successive instruction, regardless of the real size of the instruction. To achieve this, the microprocessor fills in the word(s) of each instruction with one or more stuffing words. Thus, in the case of a standard FIFO memory, the data are already aligned at the output if the FIFO memory provides information in parallel (in other words supplying words in sets of 4 in the above-mentioned example).

It is found that this traditional technique for management of alignment is not an optimum solution to enable maximum elasticity of filling the memory plane of the interfacing device by the microprocessor. The use of stuffing words prevents full use of the memory space for instruction words alone. Furthermore, this increases the number of write accesses to be made by the microprocessor.

This is why French patent application No. FR 0507988 mentioned above proposes an alternative technique that does not require word groups to be aligned in the memory plane of the interfacing device, and therefore does not need the use of stuffing words. The general principle of this alternative technique consists of managing acknowledgment of each read request (formulated by the coprocessor) taking account of the size of the group of words to be read by this request (this size being supplied by the slave block). FIG. 2 represents an example of filling the memory plane of an interfacing device with a size of 64 words, and based on this alternative technique. The exact number of physical locations in memory necessary to store the words of an instruction is allocated to this instruction (no stuffing word). Thus, in comparison with figure 1, FIG. 2 shows that in the case in which the two memory planes with the same size are in a full state (64 words used), the memory plane of the interfacing device according to the alternative technique contains more commands than the memory plane for the traditional technique.

In one particular embodiment of the alternative technique mentioned above, it is also proposed that the microprocessor should have several different size write buses. Thus, the write time (loading time) by the microprocessor in the interfacing device is optimised, taking account of the fact that the code in assembler language (2GL code) of the microprocessor includes variable size unit writes. This is due to the fact that the microprocessor code is usually written in a high level language (or 3GL for “Third Generation Language”, for example the C language) because the complexity of algorithms is such that it is impossible to write directly optimised code. Then this 3GL code is compiled to obtain the code in assembler language (2GL code) from which the code in machine language (1GL) to be executed by the microprocessor is obtained. In practice, 3GL language macro-functions are used to write the coprocessor instructions. These macro-functions are subsequently replaced in the 2GL language by variable size unit writes.

Thus for example, in the case of an 8-bit microprocessor and a 4-bit coprocessor, the coprocessor instructions form groups of variable length 4-bit words. Typically, each group of words comprises one 4-bit opcode word following by zero, one, two or three 4-bit operand words (in other words k=3, with the above-mentioned notation). If the microprocessor has two write buses, one with 4 bits and the other with 8 bits, it can write words forming an instruction using either 4-bit unit writes (in other words unit writes composed of one word), or 8-bit unit writes (in other words unit writes composed of two words). This implies that the interface of the interfacing device has two distinct inputs for 4- and 8-bit writes respectively. In other words, the sequence of unit writes included in the 2GL code includes 4-bit unit writes (“write_{—}4b( . . . )”) and 8-bit unit writes (“write_{—}8b( . . . )”).

However, the inventors of this disclosure have shown that the above-mentioned alternative technique is still not optimal, even in the particular embodiment in which the microprocessor (master block) has different size write buses.

They have demonstrated that for a sequence of unit writes, there can be an equivalent sequence for the slave block (that will read word groups written in the interfacing device using this sequence of unit writes) but that is more efficient in terms of writing by the master block.

### SUMMARY

An aspect of the disclosure proposes a method for optimising writing by a master block into an interfacing device between said master block and a slave block, said master block executing a code in machine language (1GL) obtained from an assembler language code (2GL), including a sequence of unit writes used to write word groups that are instructions that will be read and executed by said slave block and each including an operation code word and k operand words where k>0, said master block including a write bus with a size equal to N*T, where T is the size of a word and N is an integer greater than or equal to 2. The method includes a step for transformation of said assembler language code, done before said code in machine language is obtained and including the following steps:
transformation of all static unit writes comprising more than one word from said assembler language code into static one-word unit writes;
search for each set of N successive static unit one-word writes;
replace at least one set of N successive static one-word writes by one static unit N-word write, in the assembler language code.

Thus, this particular embodiment is based on a quite new and inventive approach consisting of minimising the total number of unit writes contained in the assembler language code (2GL) of the master block, due to maximisation of the number of static unit writes of N words. The machine language code (1GL) is obtained from this optimised 2GL code. In other words, the flow of data stream between the master block and the slave block is optimised.

In general, this innovating concept is applicable for all master block/slave block pairs for which the size of the write bus is N times greater than the size of the slave block instruction register, where N is an integer greater than or equal to 2.

In a first particular embodiment of the disclosure, said replacement step is such that each set of N successive static unit one-word writes is replaced by a static unit write of N words.

In this first embodiment, implementation is very simple because the linearity of the master block code is ignored.

In a second particular embodiment of the disclosure, the method also includes the following step after the search step; for each set of N successive static unit writes of a word, analyse the portion of code in assembler language between the first and the last of said N successive static unit one-word writes, so as to detect at least one non-linearity in said portion of code in assembler language. Furthermore, said replacement step is such that for each set of N successive static unit writes of a word:
if at least one non-linearity is detected, said code portion in assembler language is not modified;
if no non-linearity is detected, said code portion in assembler language is modified by replacement of said set of successive one-word static unit writes by a static unit write of N words.

In this second embodiment, the linearity of the master block code is taken into account. Thus, writing of instructions is anticipated to facilitate parallelised execution of master block and slave block codes.

According to one advantageous characteristic, said at least one non-linearity in said portion code in assembler language belongs to the group including:
jump instructions reaching an arrival point located outside said code portion in assembler language;
jump arrival points made from outside said code portion in assembler language;
dynamic writes.

According to one particular characteristic, N is equal to 2.

In one particular application, the master block is a microprocessor and the slave block is a coprocessor.

In this particular application, optimisation of writes is particularly efficient due to the fact that the microprocessor writes instructions that are inherently static writes.

Another embodiment relates to a computer program product that can be downloaded from a communication network and/or recorded on a support that can be read by computer and/or executed by a processor, said computer program product including program code instructions for execution of the steps in the above-mentioned write optimisation method when said program is executed on a computer.

### BRIEF DESCRIPTION OF THE DRAWINGS

Other characteristics and advantages of embodiments of the disclosure will become clearer after reading the following description of an embodiment given for guidance without being limitative (not all embodiments of the disclosure or claims are limited to the characteristics and advantages of this embodiment) and the appended figures, wherein:

FIG. 1 is a view of an example memory plane of an interfacing device (standard FIFO memory) with a size of 64 words, filled in using a known technique using stuffing words;

FIG. 2 is a view of an example memory plane of an interfacing device (standard FIFO memory) with a size of 64 words, filled in using a known technique not using stuffing words;

FIG. 3 shows a block diagram of an example system in which an interfacing device is placed between a master block and a slave bock, and in which the master block executes a code resulting from use of the method according to the disclosure;

FIG. 4 shows an example for obtaining a machine code from a high level code using the method according to the disclosure;

FIG. 5 shows a flow chart of a first particular embodiment of the method according to the disclosure;

FIG. 6 shows an example of a 2GL code optimised by use of the method in FIG. 5;

FIG. 7 shows a flow chart of a second particular embodiment of the method according to the disclosure; and

FIG. 8 shows an example of a 2GL code optimised by use of the method in FIG. 7.

### DETAILED DESCRIPTION OF ILLUSTRATIVE EMBODIMENTS

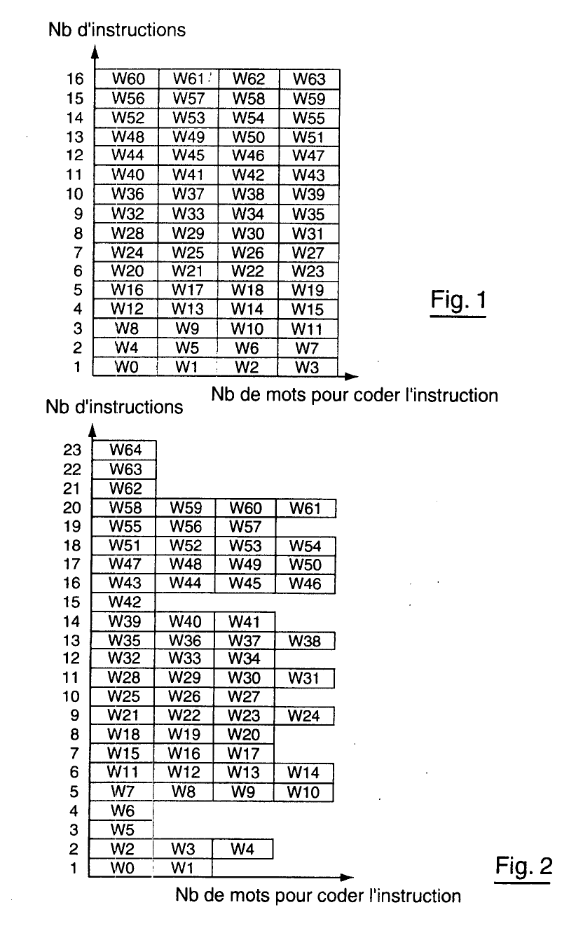

FIGS. 1 and 2 relate to prior art and have already been described above.

Identical elements and steps are denoted by the same numbers in all figures in this document.

The following definitions are also adopted:
a static write is a write of a static data (constant) in the code (for example “write_to_slave(0×33)”);
a dynamic write is a write of a code variable (for example “write_to_slave(variable_time)”).

Therefore, an aspect of the disclosure relates to a method for optimising the write done by a master block into an interfacing device between this master block and a slave block. The master block executes a code in machine language (1GL) obtained from a code in assembler language (2GL) including a sequence of unit writes used to write groups of words. Word groups are instructions that will be read and executed by the slave block, each including an operation code word and k operand words where k≧0. The master block includes a write bus with a size of N*T, where T is the size of a word and N is an integer greater than or equal to 2.

We will now describe the stage in which an embodiment of the disclosure is particularly applicable in the process for generating code in machine language (1GL code) to be executed by the master block, with reference to FIG. 4.

Conventionally, a code is written (in other words the design and development is done) using a code with a high level language (3GL code), for example the C language (or any other 3GL language). This 3GL code (reference 31) is then compiled to obtain a code in assembler language (2GL) (reference 32). This compilation step is represented by the arrow reference 35.

According to an embodiment of the disclosure, this 2GL code is transformed into an optimised 2GL code (reference 33). This transformation step is represented by the arrow reference 36. This optimised 2GL code is then converted (for example by an assembler) into a code in machine language (1GL code) (reference 34). This conversion step is represented by the arrow reference 37.

As a reminder, in prior art the 1GL code is obtained from the 2GL code directly.

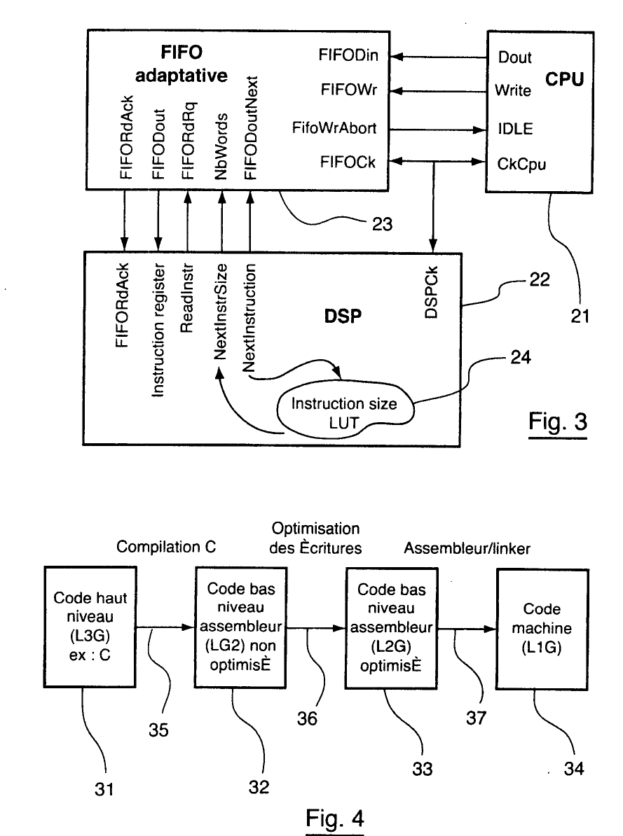

One or more embodiments of the disclosure may be used particularly (but not exclusively) in a system like that shown in FIG. 3 in which the interfacing device 23 (also called adaptive FIFO), the master block 21 and the slave block 22 are of the type shown in French patent application No. FR 0507988 mentioned above, and in which the master and the slave blocks are a microprocessor 21 (also called CPU) and a coprocessor 22 (also called DSP) respectively. In this case, the microprocessor 21 executes a code resulting from use of the method according to an embodiment of the disclosure.

For example, word groups are instructions including a 4-bit operation code word, and zero, one, two or three 4-bit operand words (in other words k=3 with the above-mentioned notation). The coprocessor 22 is a 4-bit coprocessor and the microprocessor 21 is an 8-bit microprocessor including an 8-bit write bus (in other words T=4 bits and N=2, using the above-mentioned notation).

We will now briefly describe operation of the system shown in FIG. 3. For further details, refer to the text and figures in French patent application No. 0507988 mentioned above.

The microprocessor 21 writes the data on the input bus FIFODin and sets FIFOWr to ‘1’. The data is then written in the memory plane of the interfacing device 23. If the memory plane is full, the cancel write signal FIFOWrAbort is set to ‘1’. The microprocessor must then lower its write request FIFOWr to ‘0’.

The coprocessor 22 does its read when the input FIFORdRq is set to ‘1’. The data can be read at the output from FIFODout when the acknowledge read request signal FifoRdAck is equal to ‘1’, in other words if a number of words equal to at least the size (NbWords) of the instruction associated with this read request is available on the output signal (FIFODout). NbWords gives the size of the next instruction to be read, aligned with the high order bytes of FIFODoutNext. The interfacing device 23 outputs the FIFODoutNext signal to the coprocessor 22, such that while the interfacing device serves a current read request, the coprocessor can obtain a presumed value of the instruction associated with the next read request in advance, and can provide the interfacing device with the size (NbWords) of the instruction associated with this next read request. The coprocessor obtains the size of the next instruction by decoding the opcode of the next instruction (present on FIFODoutNext), and then using the decoded opcode word to query a lookup table between the opcode words and instruction sizes (mechanism reference 24).

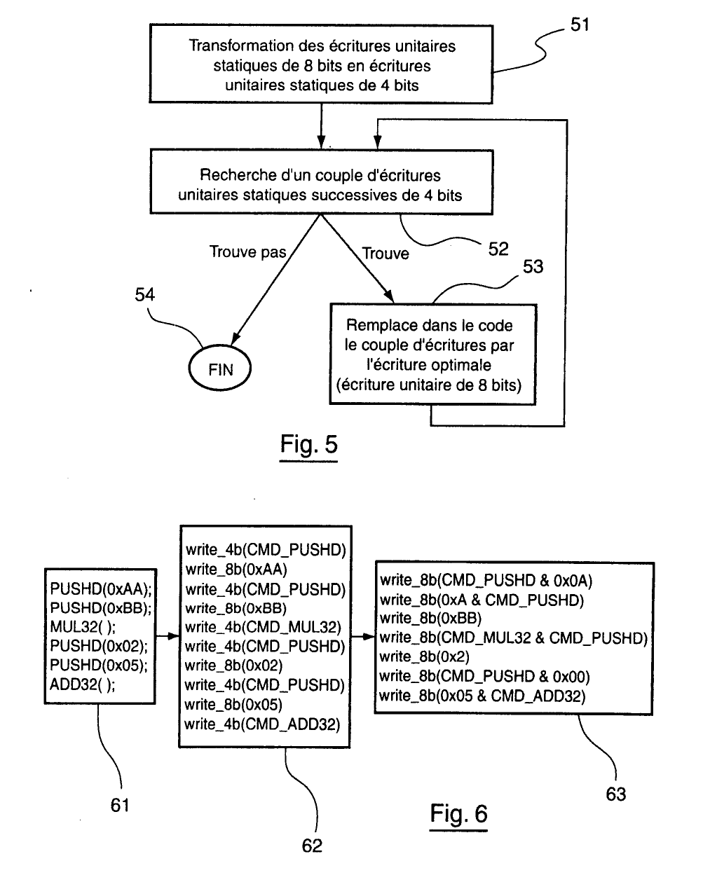

We will now present a first particular embodiment of the method with reference to the flowchart in FIG. 5, and more precisely the step (reference 36 in FIG. 4) for transformation of the 2GL code into an optimised 2GL code.

For example, this transformation step is executed on a CAD (Computer Aided Design) computer during the design and development of the microprocessor code.

We will now describe the steps included in the transformation step, once again in the context of the above-mentioned example: a 4-bit coprocessor; 8-bit microprocessor including an 8-bit write bus; instructions including a 4-bit operation code word and zero, one, two or three 4-bit operand words. In other words, it is assumed that the 2GL code comprises two unit write types: 4-bit unit writes (“write_{—}4b( . . . )”) and 8-bit unit writes (“write_{—}8b( . . . )”).

In a step 51, each of the 8-bit static unit writes in the 2GL code is converted into two 4-bit static unit writes.

In a step 52, a search is made for a pair of successive 4-bit static unit writes. Note that the dynamic writes are not touched because by definition a dynamic write writes the contents of a variable for which the value is output from an algorithm and changes with time, and therefore cannot be optimised statically.

If there is a pair in step 52, step 53 is executed in which this pair is replaced in the 2GL code by an 8-bit static unit write. Step 52 is then repeated to search for another pair of successive 4-bit static unit writes.

If no pair is found in step 52, then the end step 54 is executed.

FIG. 6 presents an example of a 2GL code optimised by using the method in FIG. 5.

More precisely, this FIG. 6 shows an example of C code reference 61, including six macro-functions describing coprocessor instructions: PUSHD(0×AA), PUSHD(0×BB), MUL32( ), PUSHD(0×02), PUSHD(0×05) and ADD32( ). After compilation, a 2GL code reference 62 is obtained in which the six above-mentioned macro-functions have been replaced by variable size unit writes: six 4-bit unit writes and four 8-bit unit writes. After transformation using the embodiment of the disclosure shown in FIG. 5, an optimised 2GL code reference 63 is obtained containing seven 8-bit unit writes. Therefore, the total number of unit writes has actually been reduced.

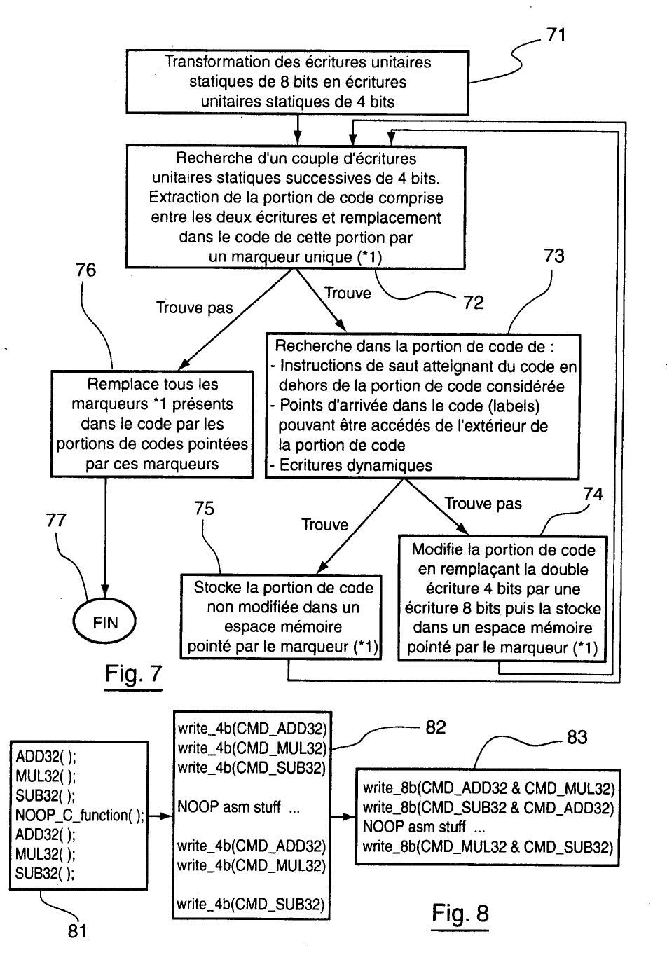

We will now present a second particular embodiment of the method with reference to the flowchart in FIG. 7, concentrating on the step (reference 36 in FIG. 4) to transform the 2GL code into an optimised 2GL code.

This second embodiment is different from the first in that it takes account of the linearity of the code to match unit writes that are at a distance from each other in the code. The code generated is not absolutely linear because there are loops, conditional jumps and non-conditional jumps that interrupt the linearity of the code.

Overall, writing of instructions (commands) is anticipated to facilitate parallelisation of microprocessor and coprocessor codes. Additional optimisation can be obtained by anticipating writes in the interfacing device. If coprocessor instructions are anticipated more, microprocessor and coprocessor codes can be executed more in parallel (provided that the interfacing device is not full, which would lead to waiting mechanisms).

In a step 71, each of the 8-bit static unit writes in the 2GL code is transformed into two 4-bit static unit writes.

In a step 72, a search is made for a pair of successive 4-bit static unit writes. Furthermore, the portion of code between the two writes in the pair is extracted and this portion is replaced in the code by a unique marker (for example “*1”).

If a pair is found in step 72, then step 73 is executed in which at least one non-linearity is detected in the extracted code portion. Non-linearity refers to:
jump instructions reaching an arrival point in the code located outside the extracted code portion;
arrival points (also called labels) of jumps made from outside the extracted code portion;
dynamic writes.

If no non-linearity is detected in step 73, then step 74 is executed in which the extracted code portion is modified, by replacing the pair of successive 4-bit static unit writes by a single 8-bit static unit write. The portion of modified code is then stored in a memory space pointed to by the above-mentioned marker. Finally, step 72 is executed again to find another pair of successive 4-bit unit writes.

If at least one non-linearity is detected in step 73, step 75 is executed in which the extracted code portion is not modified and it is stored in a memory space to which the above-mentioned marker points. Step 72 is then executed again to search for another pair of successive 4-bit static unit writes.

If no pair is found in step 72, then step 76 is executed in which all markers present in the code are replaced by portions of code pointed to by these markers. The end step 77 is then executed.

Thus, pairs of writes that can be matched although they are at a distance from each other in the code only apply to static writes, for which there is no non-linearity in the portion of code between the two. The important point is linearity of the code. If there are any jumps in the extracted portion but the writes on each side of the extracted portion are done successively and in a known manner, then the two writes can be matched.

FIG. 8 presents an example of a 2GL code optimised using the method in FIG. 7.

More precisely, this FIG. 8 illustrates an example of a C code reference 81 including seven macro-functions:
six of them describe coprocessor instructions: ADD32( ), MUL32( ), SUB32( ), ADD32( ), MUL32( ) and SUB32( );
one of them is neutral from the point of view of the interfacing device and therefore does not describe a coprocessor instruction: NOOP_C_function( ).

After compilation, a 2GL code reference 82 is obtained in which the six macro-functions describing coprocessor instructions have been replaced by six 4-bit unit writes, and the macro-function that is neutral from the point of view of the interfacing device has been replaced by the assembler code denoted “NOOP asm stuff . . . ”.

After transformation using the embodiment shown in FIG. 7, the result is an optimised 2GL code reference 83 containing three 8-bit unit writes and the assembler code denoted “NOOP asm stuff . . . ”. Therefore, the total number of unit writes has actually been reduced.

Note that the 4-bit unit writes denoted “write_{—}4b(CMD_SUB32)” and “write_{—}4b(CMD_ADD32)” have been replaced by an 8-bit unit write denoted “write_{—}8b(CMD_SUB32 & CMD_ADD32)” because the code portion between these two 4-bit unit writes (namely the assembly code denoted “NOOP asm stuff . . . ”) does not include any non-linearity in the above-mentioned sense.

Note that the disclosure is not limited to a purely hardware implantation but it could also be used in the form of a sequence of computer program instructions or any form combining a hardware part and a software part. If the method is partially or fully implanted in software form, the corresponding instruction sequence could be stored in a removable or non-removable storage means (for example such as a diskette, a CD-ROM or a DVD-ROM), this storage means being partially or fully readable by a computer or a microprocessor.

It is clear that other embodiments of the disclosure could be envisaged. In particular, other values could be used for the following parameters:
k (equal to 3 in the above example) defining the maximum number of operand words that can be included in an instruction executed by the slave block;
T (equal to 4 bits in the above example) defining the size of a word; and
   N (equal to 2 in the above example) defining the ratio between firstly the size of a write bus included in the master block and secondly the size of an instruction word (in other words the size of the instruction register used by the slave block).

At least one embodiment of the disclosure provides a method for optimising writing done by a master block in an interfacing device between this master block and a slave block, to minimise the number of unit writes that the master block makes in the interfacing device.

At least one embodiment of the disclosure provides such a method that is inexpensive and easy to implement.

In at least one embodiment of the disclosure such a method encourages parallelism of processing done by the master block and the slave block.

Although the present disclosure has been described with reference to one or more embodiments, workers skilled in the art will recognize that changes may be made in form and detail without departing from the spirit and scope of the disclosure and/or the appended claims.

What is claimed is:

1. Method for optimising writing by a master block into an interfacing device between said master block and a slave block, said master block executing a code in machine language obtained from an assembler language code, including a sequence of unit writes used to write word groups that are instructions that will be read and executed by said slave block and each including an operation code word and k operand words where k≧0, said master block including a write bus with a size equal to N*T, where T is the size of a word and N is an integer greater than or equal to 2, wherein the method comprises
transforming said assembler language code, before said code in machine language is obtained, wherein transforming comprises:
transforming all static unit writes comprising more than one word from said assembler language code into static one-word unit writes;
searching for each set of N successive static one-word unit writes; and
replacing at least one set of N successive static unit one-word writes by one static N-word unit write, in the assembler language code.

2. Method according to claim 1, wherein said replacing step is such that each set of N successive static one-word unit writes is replaced by a static N-word unit write.

3. Method according to claim 1 and further comprising the following step after the search step:
for each set of N successive static one-word unit writes, analyzing the portion of code in assembler language between the first and the last of said N successive static one-word unit writes, so as to detect at least one non-linearity in said portion of code in assembler language;
and wherein said replacing step is such that for each set of N successive static one-word unit writes:
if at least one non-linearity is detected, said code portion in assembler language is not modified; and
if no non-linearity is detected, said code portion in assembler language is modified by replacement of said set of successive one-word static unit writes by a static N-word unit write.

4. Method according to claim 3, wherein said at least one non-linearity in said portion code in assembler language belongs to the group including:
jump instructions reaching an arrival point located outside said code portion in assembler language;
jump arrival points made from outside said code portion in assembler language; and
dynamic writes.

5. Method according to claim 1, wherein N is equal to 2.

6. Method according to claim 1, wherein the master block is a microprocessor and the slave block is a coprocessor.

7. A computer program product that can be downloaded from a communication network and/or recorded on a support that can be read by computer and/or executed by a processor, characterised in that it includes program code instructions that execute the following steps when said program is executed on a computer:
optimising writing by a master block into an interfacing device between said master block and a slave block, said master block executing a code in machine language obtained from an assembler language code, including a sequence of unit writes used to write word groups that are instructions that will be read and executed by said slave block and each including an operation code word and k operand words where k≧0, said master block including a write bus with a size equal to N*T, where T is the size of a word and N is an integer greater than or equal to 2, wherein optimising comprises:
transforming said assembler language code, before said code in machine language is obtained, wherein transforming comprises:
transforming all static unit writes comprising more than one word from said assembler language code into static one-word unit writes;
searching for each set of N successive static one-word unit writes; and
replacing at least one set of N successive static unit one-word writes by one static N-word unit write, in the assembler language code.
